(19) United States
(12) Patent Application Publication
(10) Pub. No.: US 2026/0016127 A1
(43) Pub. Date: Jan. 15, 2026

(54) PORTABLE BLOWDOWN SYSTEM

(71) Applicant: Moneyhun Equipment Sales & Service Co., Inc., Rock Springs, WY (US)

(72) Inventors: John MONEYHUN, Rock Springs, WY (US); Charles WHITAKER, Rock Springs, WY (US)

(21) Appl. No.: 18/767,728

(22) Filed: Jul. 9, 2024

(51) Int. Cl. F17D 3/10

(52) U.S. Cl. CPC F17D 3/10

(57) ABSTRACT

A portable blowdown system (PBS) and method de-inventories natural gas (NG) equipment in a NG system for servicing. The method comprises connecting the PBS to the NG equipment. The NG in the NG equipment is transferred to a blowdown drum of the PBS. Residual NG in the NG equipment is destroyed with a residual gas destruction (RGD) unit of the PBS. The NG in the blowdown drum of the PBS is transferred to the NG equipment after servicing.

### BACKGROUND

The present invention relates generally to a portable blowdown system and method for removing, temporarily storing and reinjecting gas of a segment of a petroleum system, such as a pipeline, to resist emitting gas into the atmosphere when the segment is being maintained.

In petroleum production, equipment may need to be maintained or serviced. Removing or disconnecting the equipment can release petroleum associated gas into the atmosphere. Some governments have increased regulatory requirements for, and many companies have specified, a safe, clean and efficient means of managing or eliminating emission of gas.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic diagram of an example portable blowdown system (PBS) according to an embodiment.

FIG. 2 is an example piping and instrumentation diagram (P&ID) of the PBS of FIG. 1 according to an embodiment.

FIG. 3 is a flowchart of an example method for de-inventorying a natural gas (NG) equipment in a NG system according to an embodiment.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

An initial overview of the inventive concepts are provided below and then specific examples are described in further detail later. This initial summary is intended to aid readers in understanding the examples more quickly, but is not intended to identify key features or essential features of the examples, nor is it intended to limit the scope of the claimed subject matter.

The term natural gas (NG) is used herein to refer to natural gas and any other petroleum associated gas from oil production processes. Equipment in the production or petroleum processes may need to be serviced or maintained. Removing such equipment from service, or disconnecting such equipment from the system, can result in the emission of petroleum associated gas. Reducing or eliminating such emission is desirable for environmental concerns and/or regulatory requirements.

A portable blowdown system (PBS) and method are presented that can temporarily hold an inventory of natural gas (NG) for segments (e.g. NG equipment) of a NG system (e.g. a NG pipeline) that may need to be de-inventoried for maintenance activities. The PBS and method can destroy small amounts of residual NG that may be left in the NG equipment and/or the PBS system. The PBS and method can re-injected the inventory of NG back into the NG system once the maintenance activity is complete. The PBS can be portable so that it can be taken to any NG equipment along the NG system (e.g. pipeline) to aid in the de-inventory process before maintenance. The PBS and method can resist a release of NG to atmosphere while the NG equipment is serviced by transferring the NG from the NG equipment, temporarily storing the NG from the NG equipment, and reinjecting the NG from the NG equipment back into the NG equipment while destroying any residual NG.

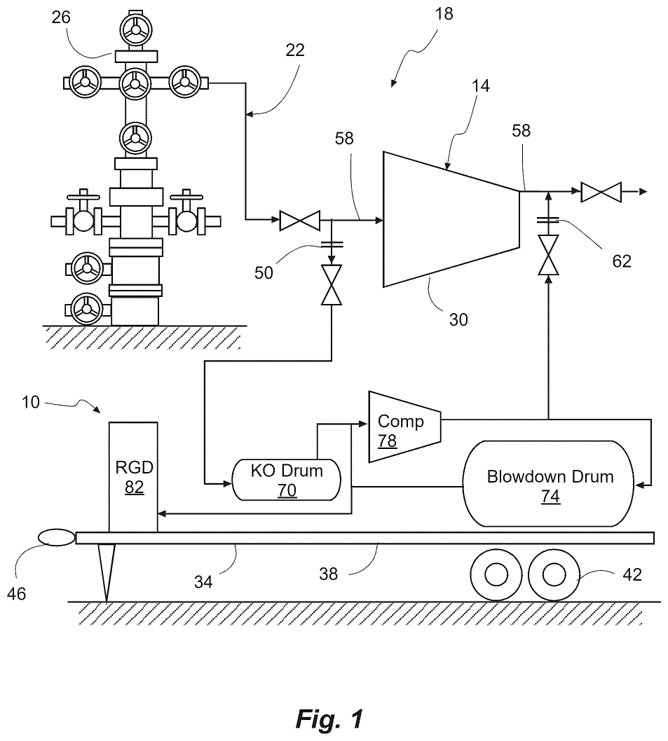

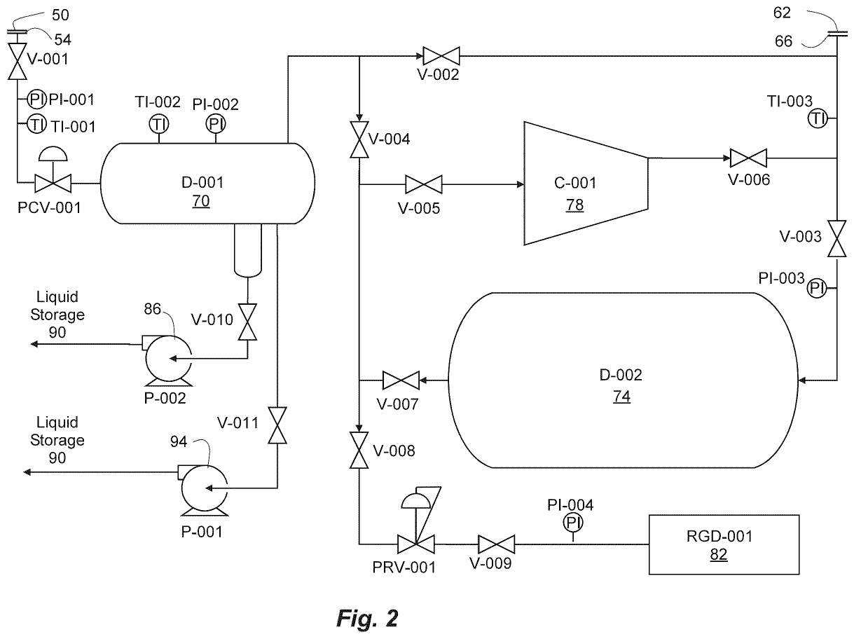

Referring to FIGS. 1 and 2, an example portable blowdown system (PBS) 10 is shown according to some embodiments for de-inventorying natural gas (NG) equipment 14 (i.e. one or more) in a NG system 18. The NG system 18 can comprise a flow or process of NG, such as a pipeline 22 or processing plant. The NG equipment 14 can comprise a segment of the NG system 18, such as a segment of a pipeline 22, a wellhead 26, a compressor 30, a pump, a dehydrator, etc. Thus, the PBS 10 can resist a release of NG from the NG equipment 14 during servicing by removing and temporarily storing the NG from the NG equipment 14.

The PBS 10 can have a platform 34 transportable to the NG system proximate the NG equipment 14. In one aspect, the PBS 10 and the platform 34 can comprise a trailer 38 with wheels 42 and a hitch 46 to be transported by a tractor or a truck. The PBS 10 can have an inlet 50 carried by the platform 34 that can be coupled to the NG equipment 14. The inlet 50 can comprise a connection 54 for coupling to the NG equipment 14. The inlet 50 and the connection 54 can couple directly to the NG equipment 14 or to an NG line 58 upstream or downstream of the NG equipment 14. The PBS 10 can have an outlet 62 carried by the platform 34 that can be coupled to the NG equipment 14 at a different and/or opposite side of the NG equipment 14. The outlet 62 can comprise another connection 66 for coupling to the NG equipment 14. The outlet 62 and the connection 66 can couple directly to the NG equipment 14 or to the NG line 58 upstream or downstream of the NG equipment 14.

A liquid knockout drum 70 (D-001) can be carried by the platform 34 and can be coupled to the inlet 50 to contain any liquid in the NG. A blowdown drum 74 (D-002) can be carried by the platform 34 and can be coupled to the liquid knockout drum 70 to receive the NG from the NG equipment 14. A compressor 78 (C-001) can be carried by the platform 34 and can be coupled to the liquid knockout drum 70. The compressor 78 can direct the NG from the NG equipment 14 to the blowdown drum 74. In addition, the compressor 78 can be coupled to the outlet 62. The compressor 78 can direct the NG from the blowdown drum 74 back to the NG equipment 14.

A residual gas destruction (RGD) unit 82 (RGD-001) can be carried by the platform and can be coupled to the liquid knockout drum 70 and the blowdown drum 74. The RGD 82 can destroy residual gas from the NG equipment 14 and the blowdown drum 74. The RGD 82 can comprise a flare, a combustor and/or a catalytic heater to destroy the NG efficiently.

A water pump 86 (P-002) can be carried by the platform 34 and can be coupled to the liquid knockout drum 70 to pump water from the liquid knockout drum 70 to a liquid storage 90. A hydrocarbon pump 94 (P-001) can be carried by the platform 34 and can be coupled to the liquid knockout drum 70 to pump hydrocarbons from the liquid knockout drum 70 to the liquid storage 90 or a different liquid storage.

Referring to FIG. 2, various components of the PBD 10 can be identified in Table 1:

TABLE 1

| | |
|---|---|
| P-001 | Knockout hydrocarbon pump |
| P-002 | Knockout water pump |
| D-001 | Liquid knockout drum |
| D-002 | Blowdown drum |
| C-001 | Gas compressor |
| RGD-001 | Residual gas destruction |
| V-001 to V-011 | Valves |
| PVC-001 | Pressure control valve |
| PRV-001 | Pressure reducing valve |
| PI-001 to PI-003 | Pressure gauges |
| TI-001 to TI-003 | Temperature gauges |

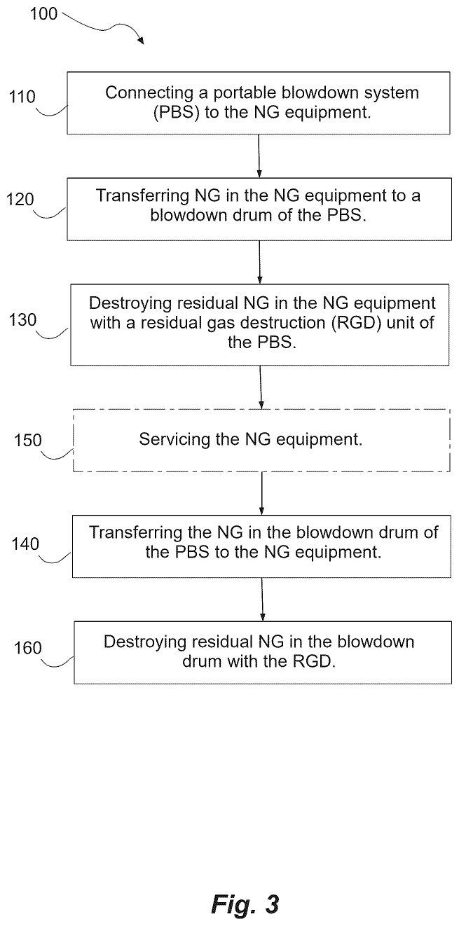

Referring to FIG. 3, an example method 100 for de-inventorying a natural gas (NG) equipment 14 in a NG system 18 is shown according to an embodiment. The method 100 can comprise connecting 110 a portable blowdown system (PBS) 10 to the NG equipment 14. The method 100 can comprise transferring 120 the NG in the NG equipment 14 to a blowdown drum 74 of the PBS 10. The method 100 can comprise destroying 130 residual NG in the NG equipment 14 with a residual gas destruction (RGD) unit 82 of the PBS 10. The method 100 can comprise transferring 140 the NG in the blowdown drum 74 of the PBS 10 to the NG equipment 14 (in one aspect, after servicing 150 the NG equipment 14).

The method 100 can resist a release of the NG to atmosphere while the NG equipment 14 is serviced by transferring 120 the NG from the NG equipment 14, temporarily storing the NG from the NG equipment 14, and reinjecting (i.e. transferring 140) the NG from the NG equipment 14 back into the NG equipment 14, while destroying 130 any residual NG.

In one aspect, the method 100 can further comprise destroying 160 residual NG in the blowdown drum 74 with the RGD 82. Thus, there the NG in the PBS 10 has been eliminated to resist emission of NG from the PBS 10 into the atmosphere.

In another aspect, the method 100 can further comprise disconnecting the NG equipment 14 from the NG in the NG system 18 prior to transferring 120 the NG from the NG equipment 14 to the blowdown drum 74. The method 100 can comprise reconnecting the NG equipment 14 to the NG in the NG system 18 after transferring 140 the NG in the blowdown drum 74 to the NG equipment 14, and thus after the pressure of the NG in the NG equipment 14 has been increased to be nearly equal to the NG in the NG system 18.

In another aspect, the method 100 can further comprise isolating the NG equipment 14 from a flow of NG of the NG system 18 prior to transferring 120 NG from the NG equipment 14 to the blowdown drum 74. The method 100 can comprise reintroducing the NG equipment 14 to the flow of NG of the NG system 18 after transferring 140 the NG in the blowdown drum 74 to the NG equipment 14, and thus after the pressure of the NG in the NG equipment 14 has been increased to be nearly equal to the pressure of the flow of NG in the NG system 18.

In another aspect, the method 100 can further comprise using a compressor 78 to transfer 120 the NG from the NG equipment 14 to the blowdown drum 74. In addition, and conversely, the method 100 can comprise using the compressor 78 to transfer 140 the NG from the blowdown drum 74 to the NG equipment 14 after servicing 150 the NG equipment 14.

In another aspect, the method 100 can further comprise transferring 120 the NG from the NG equipment 14 through a liquid knockdown drum 70 of the PBS 10 to remove liquid from the NG.

In another aspect, transferring 120 the NG in the NG equipment 14 to the blowdown drum 74 can further comprise directing the NG in the NG equipment 14 from the NG equipment 14, through a liquid knockout drum 70 of the PBS 10, to knockout liquid in the NG; and directing the NG in the NG equipment 14 to the blowdown drum 74 of the PBS 10 to store the NG, until a pressure of the NG between the NG equipment 14 and the blowdown drum 74 equalizes.

In another aspect, transferring 120 the NG in the NG equipment 14 to the blowdown drum 74 can further comprise removing remaining NG in the NG equipment 14 through the liquid knockout drum 70 to the blowdown drum 74 using a compressor 78 of the PBS 10 until a pressure of the NG in the NG equipment 14 is at a minimum pressure determined by the compressor 78.

In another aspect, transferring 120 the NG in the NG equipment 14 to the blowdown drum 74 can further comprise directing residual NG in the NG equipment 14 through the liquid knockout drum 70 to a residual gas destruction (RGD) unit 82 to destroy the residual NG from the NG equipment 14.

In another aspect, transferring 140 the NG in the blowdown drum 74 to the NG equipment 14 can further comprise directing the NG in the blowdown drum 74 into the NG equipment 14 using the compressor 78 until the minimum pressure is reached.

In another aspect, transferring 140 the NG in the blowdown drum 74 to the NG equipment 14 can further comprise directing residual gas in the blowdown drum 74 to the RGD 82 to destroy the residual NG from the blowdown drum 74.

In another aspect, the method 100 can further comprise positioning the PBS 10 proximate the NG equipment 14 prior to connecting 110; disconnecting the PBS 10 from the NG equipment 14 after transferring 120 the NG from the NG equipment 14; and positioning the PBS 10 away from the NG equipment 14 after disconnecting the PBS 10. In another aspect, the method 100 can comprise servicing 150 the NG equipment 14. In another aspect, the method 100 can comprise repositioning the PBS 10 proximate the NG equipment 14 after the NG equipment 14 is serviced 150; and reconnecting the PBS 10 to the NG equipment 14.

Referring to FIG. 3, various valve positions and equipment operation of the PBS 10 are identified in Table 2 with respect to the method:

TABLE 2

| | | | | | Blowdown | |
|---|---|---|---|---|---|---|
| | High | Equilibration | Equipment | | Drum | |
| | pressure to | to Min | Residual Gas | Re- | Residual Gas | Liquid |
| | Equilibration | Pressure | Destruction | Injection | Destruction | Pump Out |
| V-001 | open | open | open | closed | closed | closed |
| V-002 | open | closed | closed | closed | closed | closed |
| V-003 | open | open | closed | closed | closed | closed |
| V-004 | closed | open | open | closed | closed | closed |
| V-005 | closed | open | closed | open | closed | closed |
| V-006 | closed | open | closed | open | closed | closed |
| V-007 | closed | closed | closed | open | open | closed |
| V-008 | closed | closed | open | closed | open | closed |
| V-009 | closed | closed | open | closed | open | closed |
| V-010 | closed | closed | closed | closed | closed | open |
| V-011 | closed | closed | closed | closed | closed | open |
| PCV-001 | open | open | open | closed | closed | closed |
| PRV-001 | closed | closed | open | closed | open | closed |
| C-001 | off | on | off | on | off | closed |
| RGD-001 | off | off | on | off | on | closed |

With respect to high pressure NG equipment to equilibration, high pressure NG from the NG equipment 14 can flow to the blowdown drum 74 (D-002) until the pressure is balanced. The NG can flow through valve V-001 and then be regulated via a control valve PCV-001 to control the rate of equilibration. The NG can continue to flow through the liquid KO drum 70 (D-001) to knock out any liquids, and through valves V-002/V-003 and into the blowdown drum 74 (D-002) until the pressure between the NG equipment 14 and the blowdown drum 74 is equal.

With respect to equilibration to minimum pressure in the NG equipment 14, the remaining NG from the NG equipment 14 can move to the blowdown drum 74 (D-002) using a compressor 78 until a minimum pressure point is reached as set by the compressor 78. The NG can flow through valves V-001/PCV-001 (PCV-001 can be fully open for this process) and continue to flow through the liquid KO drum 70 (D-001) to knock out any liquids. The NG can then flow through valves V-004/V-005 and then through the compressor 78 (C-001) which can be the driving force for bringing the pressure in the NG equipment 14 down to the minimum pressure. The NG can continue to flow through valves V-006/V-003 and into blowdown drum 74 (D-002) until the NG equipment 14 is at the minimum pressure.

With respect to NG equipment 14 residual gas destruction, a small amount of residual NG left in the NG equipment 14 can be destroyed to take the NG equipment 14 from minimum pressure to atmospheric pressure. The NG can flow through valves V-001/PCV-001 (PCV-001 can be fully open for this process) and continue to flow through the liquid KO drum 70 (D-001) to knock out any liquids. The NG can then flow through valves V-004/V-008 and then be regulated via a reducing valve PRV-001 to get the downstream pressure at a correct condition for the residual gas destruction unit 82 (RGD-001). The residual NG can continue to flow through valve V-009 and into the RGD 82 (RGD-001) where the residual NG can be destroyed. At this point, the NG equipment 14 is de-inventoried and the PBS 10 can be disconnected and transported away to begin maintenance activities.

With respect to re-injection, after the NG equipment 14 is serviced and/or maintenance activities are complete, the NG in the blowdown drum 74 can be re-injected back into the NG equipment 14 and/or the NG system 18. The NG from the blowdown drum 74 (D-002) can flow through valves V-007/V-005 and into the compressor 78 (C-001). The NG can continue to flow through valve V-006 and into the NG equipment 14 to introduce the NG back into the NG equipment 14 and/or the NG system 18. The NG can be sent back into the NG equipment 14 and/or the NG system 18 until the minimum pressure as set by the compressor 78 is reached.

With respect to blowdown drum residual gas destruction, a small amount of residual NG left in the blowdown drum 74 can be destroyed to take the blowdown drum 74 from minimum pressure to atmospheric pressure. The residual NG can flow from the blowdown drum 74 (D-002) through valves V-007/V-008 and then be regulated via a pressure reducing regulator PRV-001 to get the downstream pressure at the correct conditions for the RGD 82 (RGD-001). The residual NG can continue to flow through valve V-009 and into the RGD 82 (RGD-001) where the residual NG can be destroyed.

With respect to liquid pump out, the liquid that was knocked out previously can be removed. Pumps 86 and 94 (P-002 and P-001) can pump liquids through valves V-011 and V-010, respectively, to a different storage system 90.

In another aspect, any residual NG in the liquid knockout drum 70 can be directed to the RGD 82 for destruction.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the terms “approximately” and “about” are used interchangeably to provide flexibility to a numerical range endpoint by providing that a given value may be “a little above” or “a little below” the endpoint. It is understood that express support is intended for exact numerical values in this specification, even when the term “about” is used in connection therewith.

Approximately and about refer to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A method for de-inventorying a natural gas (NG) equipment in a NG system, the method comprising:
a) connecting a portable blowdown system (PBS) to the NG equipment;
b) transferring NG in the NG equipment to a blowdown drum of the PBS;
c) destroying residual NG in the NG equipment with a residual gas destruction (RGD) unit of the PBS; and
d) transferring the NG in the blowdown drum of the PBS to the NG equipment.

2. The method of claim 1, further comprising:
destroying residual NG in the blowdown drum with the RGD.

3. The method of claim 1, wherein the PBS resists a release of NG to atmosphere while the NG equipment is serviced.

4. The method of claim 1, further comprising:
disconnecting the NG equipment from NG in the NG system prior to transferring NG from the NG equipment to the blowdown drum; and
reconnecting the NG equipment to the NG in the NG system after transferring the NG in the blowdown drum to the NG equipment.

5. The method of claim 1, further comprising:
isolating the NG equipment from a flow of NG of the NG system prior to transferring NG from the NG equipment to the blowdown drum; and
reintroducing the NG equipment to the flow of NG of the NG system after transferring NG in the blowdown drum to the NG equipment.

6. The method of claim 1, further comprising:
using a compressor to transfer NG from the NG equipment to the blowdown drum; and
using the compressor to transfer NG from the blowdown drum to the NG equipment.

7. The method of claim 1, further comprising:
transferring NG from the NG equipment through a liquid knockdown drum of the PBS to remove liquid from the NG.

8. The method of claim 1, wherein transferring NG in the NG equipment to the blowdown drum further comprises:
directing NG in the NG equipment from the NG equipment through a liquid knockout drum of the PBS to knockout liquid in the NG and directing the NG in the NG equipment to the blowdown drum of the PBS to store the NG until a pressure of the NG between the NG equipment and the blowdown drum equalizes.

9. The method of claim 8, wherein transferring NG in the NG equipment to the blowdown drum further comprises:
removing remaining NG in the NG equipment through the liquid knockout drum to the blowdown drum using a compressor of the PBS until a pressure of the NG in the NG equipment is at a minimum pressure determined by the compressor.

10. The method of claim 9, wherein transferring NG in the NG equipment to the blowdown drum further comprises:
directing residual NG in the NG equipment through the liquid knockout drum to a residual gas destruction (RGD) unit to destroy the residual NG.

11. The method of claim 9, wherein transferring NG in the blowdown drum to the NG equipment further comprises:
directing NG in the blowdown drum into the NG equipment using the compressor until the minimum pressure is reached.

12. The method of claim 1, wherein transferring NG in the blowdown drum to the NG equipment further comprises:
directing residual gas in the blowdown drum to the RGD.

13. The method of claim 1, further comprising:
a) positioning the PBS proximate the NG equipment prior to connecting;
b) disconnecting the PBS from the NG equipment after transferring NG from the NG equipment;
c) positioning the PBS away from the NG equipment after disconnecting the PBS;
d) servicing the NG equipment;
e) repositioning the PBS proximate the NG equipment after the NG equipment is serviced; and
f) reconnecting the PBS to the NG equipment.

14. A method for de-inventorying a natural gas (NG) equipment in a NG system, the method comprising:
a) positioning a portable blowdown system (PBS) proximate the NG equipment;
b) coupling the PBS to the NG equipment;
c) directing NG in the NG equipment from the NG equipment through a liquid knockout drum of the PBS to knockout liquid in the NG and to a blowdown drum of the PBS to store the NG until a pressure of the NG between the NG equipment and the blowdown drum equalizes;
d) removing remaining NG in the NG equipment through the liquid knockout drum to the blowdown drum using a compressor of the PBS until a pressure of the NG in the NG equipment is at a minimum pressure determined by the compressor;
e) directing residual NG in the NG equipment through the liquid knockout drum to a residual gas destruction (RGD) unit to destroy the residual NG;
f) disconnecting the PBS from the NG equipment;
g) positioning the PBS away from the NG equipment;
h) repositioning the PBS proximate the NG equipment after the NG equipment is serviced;
i) reconnecting the PBS to the NG equipment;
j) directing NG in the blowdown drum into the NG equipment or the NG system using the compressor until the minimum pressure is reached;
k) directing residual gas in the blowdown drum to the RGD; and
l) directing liquid from the liquid knockout to liquid storage.

15. A portable blowdown system (PBS) configured to de-inventory a natural gas (NG) equipment in a NG system, comprising:
a) a platform transportable to the NG system proximate the NG equipment;
b) an inlet carried by the platform and configured to be coupled to the NG equipment;
c) an outlet carried by the platform and configured to be coupled to the NG equipment;
d) a liquid knockout drum carried by the platform and coupled to the inlet and configured to contain liquid from the NG;
e) a blowdown drum carried by the platform and coupled to the liquid knockout drum and configured to receive NG from the NG equipment;
f) a compressor carried by the platform and coupled to the liquid knockout drum and configured to direct NG from the NG equipment to the blowdown drum, and coupled to the outlet and configured to direct NG from the blowdown drum back to the NG equipment; and
g) a residual gas destruction (RGD) unit coupled to the liquid knockout drum and the blowdown drum and configured to destroy residual gas from the NG equipment and the blowdown drum.

16. The PBS of claim 15, further comprising:
a water pump carried by the platform and coupled to the liquid knockout drum and configured to pump water from the liquid knockout drum.

17. The PBS of claim 15, further comprising:
a hydrocarbon pump carried by the platform and coupled to the liquid knockout drum and configured to pump hydrocarbons from the liquid knockout drum.

18. The PBS of claim 15, wherein:
the inlet comprises a connection for coupling to the NG equipment; and
the outlet comprises another connection for coupling to the NG equipment.

19. The PBS of claim 15, wherein the platform comprises a trailer with wheels.

20. The PBS of claim 15, wherein the PBS is configured to resist a release of NG to atmosphere while the NG equipment is serviced.
